(19) United States
(12) Patent Application Publication
(10) Pub. No.: US 2006/0010133 A1
(43) Pub. Date: Jan. 12, 2006

(54) Management of a scalable computer system

(76) Inventors: James J. Bozek, Bothell, WA (US); Conor B. Flynn, Seattle, WA (US); Deborah L. McDonald, Bellevue, WA (US); Vinod Menon, Bellevue, WA (US); Paul A. Skoglund, Bellevue, WA (US)

Correspondence Address: LIEBERMAN & BRANDSDORFER, LLC, 802 STILL CREEK LANE, GAITHERSBURG, MD, 20878, US

(21) Appl. No.: 10/888,766

(22) Filed: Jul. 9, 2004

(51) Int. Cl. G06F 17/30

(52) U.S. Cl. 707/10

(57) ABSTRACT

A method and system for remotely managing a scalable computer system is provided. Elements of an associated tool are embedded on a server and associated console. A service processor for each partition is provided, wherein the service processor supports communication between the server and the designated partition. An operator can discover and validate availability of elements in a computer system. In addition, the operator may leverage data received from the associated discovery and validation to configure or re-configure a partition in the system that support projected workload.

### BACKGROUND OF THE INVENTION

1. Technical Field

This invention relates to a tool for managing a scalable computer system. More specifically, the tool supports configuration and administration of each member and resource of the scalable system.

2. Description of the Prior Art

Multiprocessor systems by definition contain multiple processors, also referred to herein as CPUs, that can execute multiple processes or multiple threads within a single process simultaneously, in a manner known as parallel computing. In general, multiprocessor systems execute multiple processes or threads faster than conventional uniprocessor systems, such as personal computers (PCs), that execute programs sequentially. The actual performance advantage is a function of a number of factors, including the degree to which parts of a multithreaded process and/or multiple distinct processes can be executed in parallel and the architecture of the particular multiprocessor system at hand. One critical factor is the cache that is present in modern multiprocessors. Accordingly, performance can be optimized by running processes and threads on CPUs whose caches contain the memory that those processes and threads are going to be using.

Modern multiprocessor computer systems are scalable computer systems that are generally comprised of a plurality of nodes that are interconnected through cables. Scalable computer systems support addition and/or removal of system resources either statically or dynamically. The benefit of a scalable system is that it adapts to changes associated with capacity, configuration, and speed of the system. A scalable system may be expanded to achieve better utilization of resources without stopping execution of application programs on the system.

A scalable multiprocessor computing system can be partitioned with hardware to make a subset of the resources on a computer available to a specific application. A partition is an aggregation of cache coherent nodes that are capable of executing one operating system image. Each partition has one primary node and optional secondary nodes. In a dynamically partitioned system, the allocation of resources may be reconfigured during operation to more efficiently run applications. Dynamically partitionable scalable computer systems are complex to manage. Several prior art solutions provide support for manual configuration of system resources. However, such solutions do not support dynamic partitioning of system resources. Accordingly, manual configuration of system resources requires temporary shut-down of the affected resources until completion of the reconfiguration.

One prior art solution is presented in U.S. Pat. No. 6,260,068 to Zalewski et al., which proposes dynamic migration of hardware resource among partitions in a multi-partition computer system. Each partition has at least one processor, memory, and I/O circuitry. Some of the resources in the partition may be assignable to another partition. A mechanism is employed that enables dynamic reconfiguration of a partition by reassigning resources of one partition to another partition. The hardware resources are reassigned based upon requests from one partition to a second partition. However, Zalewski et al. is limited to migrating hardware resources among partitions in a multi-partition computing system, and fails to address high level management of resources within a partition.

Therefore what is desirable is a tool that provides dynamic configuration and management of a scalable computer system and system resources.

### SUMMARY OF THE INVENTION

This invention comprises a tool for creating a scalable computer system, and for managing functions of the system created.

In a first aspect of the invention, a method is provided for managing a computer system. A scalable computer system is creating from an unassigned scalable node. In addition, a scalable function within the system, as well as a scalable partition function within a partition of the system, is managed remotely.

In another aspect of the invention, an article is provided in a computer-readable signal-bearing medium. Means in the medium are provided for creating a scalable computer system from an unassigned node. In addition, means in the medium are provided for remotely managing a scalable function, as well as for remotely managing a scalable partition function within a partition of the system.

In yet another aspect of the invention, a computer management tool is provided. The tool includes a coordinator adapted to create a scalable computer system from an unassigned node. A remote function manager is provided to control a scalable function, and a remote partition manager is provided to control a scalable partition function.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a computer management tool according to the preferred embodiment of this invention, and is suggested for printing on the first page of the issued patent.

FIG. 2 is a flow chart illustrating an overview of functionality of elements of the management tool.

FIG. 3 is a flow chart illustrating the process of discovering system components.

FIG. 4 is a flow chart illustrating the process of validating of system components.

FIG. 5 is a flow chart illustrating the process of configuring a partition.

FIG. 6 is a flow chart illustrating the process of delivering power to a system component.

FIG. 7 is a flow chart illustrating the process of removing power from a system component.

FIG. 8 is a flow chart illustrating the process of configuring a remote I/O enclosure.

### DESCRIPTION OF THE PREFERRED EMBODIMENT

### Overview

A tool that provides comprehensive hardware partition management of a scalable computer system. The tool provides an overview of all of the nodes in the computer system, including details pertaining to scalable nodes and scalable partitions. The tool enables an operator to create a scalable computer system from an unassigned scalable node, and to manage scalable partition functions. The tool leverages the service processor to determine which nodes are part of the scalable system. Based upon a communication protocol, the nodes which respond to a discovery request within the time frame provided may be added to the system. Following discovery request, the tool may validate which ports in the system are functioning. Results received from the discovery request and/or validation of ports enables respondents to be integrated into the system. Accordingly, the tool is a single interface that enables management of a scalable computer system.

### Technical Details

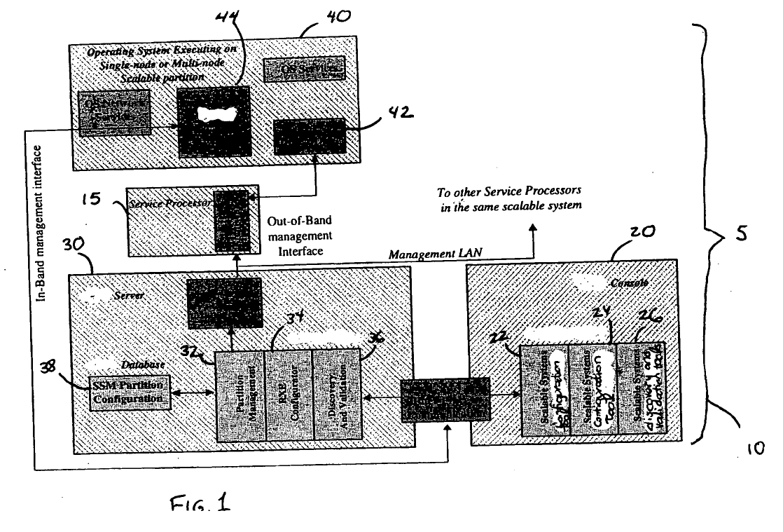

FIG. 1 is a diagram (10) showing the physical placement of the management tool (5) within the scalable computer system. The primary elements that support functionality of the tool with the system include a management console (20), a management server (30), a service processor (15), and an operating system executing on a node in a partition (40). The management console (20) has three embedded tools: a system discovery tool (22), a system validation tool (24), and a system configuration tool (26). The console tools (22), (24), and (26) are shown embedded on a console (20) physically separated from the management server (30). In one embodiment, the console (20) and the server (30) can be two separate machines, or merged into one machine. Each of the console tools (22), (24), and (26), support system discovery, system validation, and partition management, respectively. The management server (30) includes an application database (38) to store partition information, and three embedded tool components: a partition management tool (32), a configuration tool to enable and disable slots in the remote I/O enclosure (34), and a discovery and validation tool to support pinging tasks (36). The embedded tool components of the server provide supporting infrastructure for the corresponding console components. The partition management tool embedded in the server (32) functions in conjunction with the scalable system configuration tool of the console (22). Similarly, the configuration tool (34) embedded in the server functions in conjunction with the scalable system configuration tool (24) embedded in the console (20), and the discovery and validation tool (36) embedded in the server functions in conjunction with the scalable systems discovery and scalable systems validation tools (26) embedded in the console (20). Each partition is in communication with the service processor (15) on its primary node. In one embodiment, a system with multiple partitions may include multiple service processors with each service processor facilitating communication with the management server (30). Each partition (40) is shown to include a service processor device driver (42) and an agent (44) of the management tool. The device driver (42) supports communication between the service processor (15) and the partition (40). Similarly, the agent (44) supports communications between the management tool and the partition (40). Accordingly, the management tool includes elements embedded within different components of the system to enable control of such elements from a remote console.

As shown in FIG. 1, the elements of the tool (5) are shown embedded within a server and console of the management application. Communication between the management console (20) and the server (30) are in-band, i.e. through internal communication protocol, facilitated with use of the management tool (5). Similarly, communication from the service processor (15) to any partition (40) in the system and from the tool (5) to any partition (40) in the system is in-band. However, all communications from the server (30) to the service processor (15) are out-of-band, i.e. through an external communication protocol. Accordingly, the tools and applications embedded in the console and server, respectively, provide all of the elements to support management of the nodes and partitions within the system.

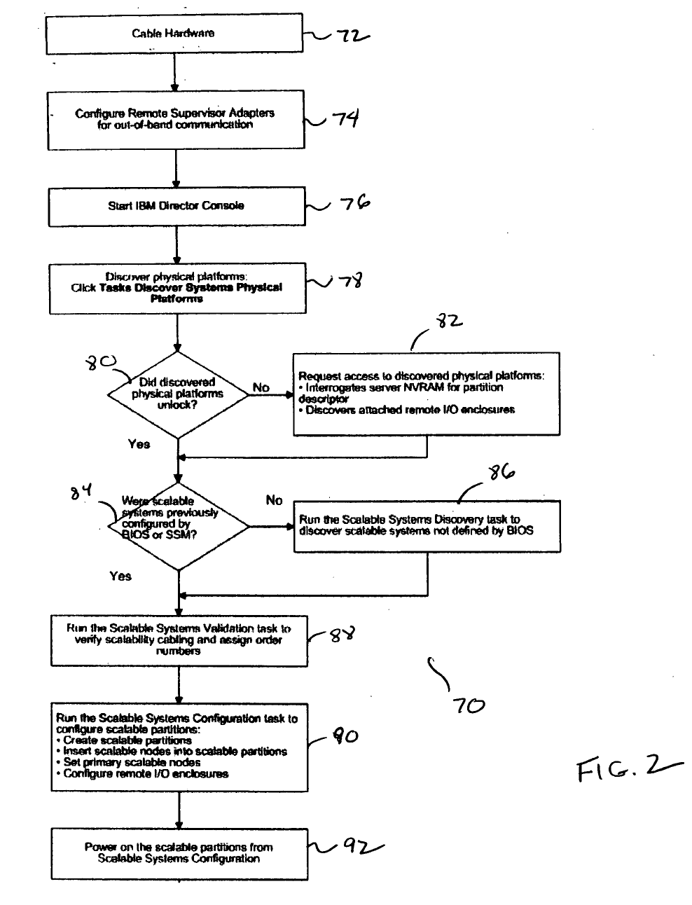

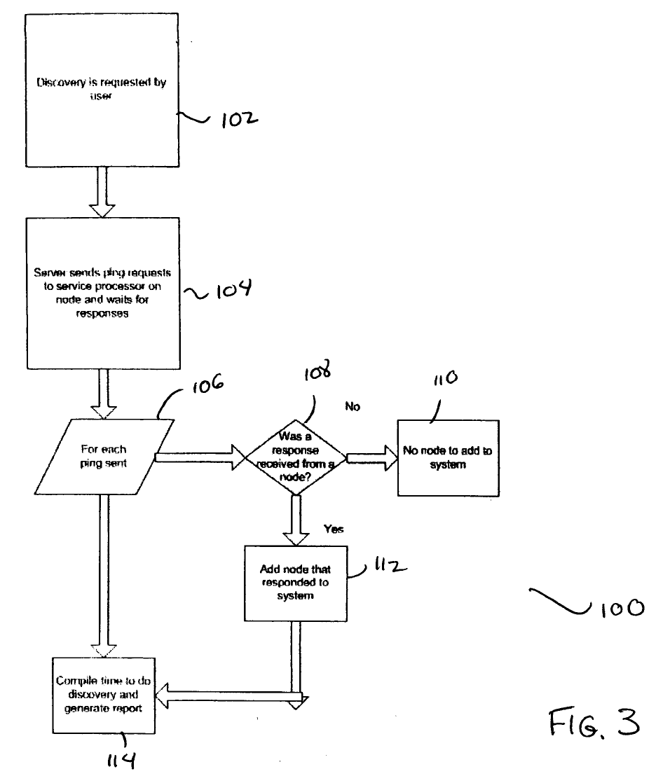

FIG. 2 is a flow chart (70) showing a high level view of the management tool and how it manages partitions and partition functions. The first step requires the hardware of the computer system to be physically connected to the management tool (72). Thereafter, the service processor is configured for external communication with the management tool (74). In one embodiment, this includes setting up an internet protocol address for each service processor (15), and configuring user identifiers and associated passwords with the service processor (15). Once steps (72) and (74) are complete, the management console (20) is started (76), and the physical platforms (nodes) of the computer system are discovered (78). During the discovery at step (78), the user may be requested to furnish their identifier and associated password. Following step (78), a test is conducted to determine if the user identifier and associated password were valid (80). A negative response to the test at step (80), will result in the user requesting access to the previously discovered physical platforms (nodes) of the computer system (82). Such a request may include interrogating the server non-volatile random access memory (NVRAM) for the partition descriptor. Following step (82) or a positive response to the test at step (80), a subsequent test is conducted to determine if scalable elements within the system have been configured by either the basic input/output system (BIOS) in the partition or the management tool (84). A negative response to the test at step (84) is an indication that there may be scalable elements within the system that are not defined by the BIOS. In such a case, a discovery function is executed (86), as shown in detail in FIG. 3, to identify the undefined scalable elements (86).

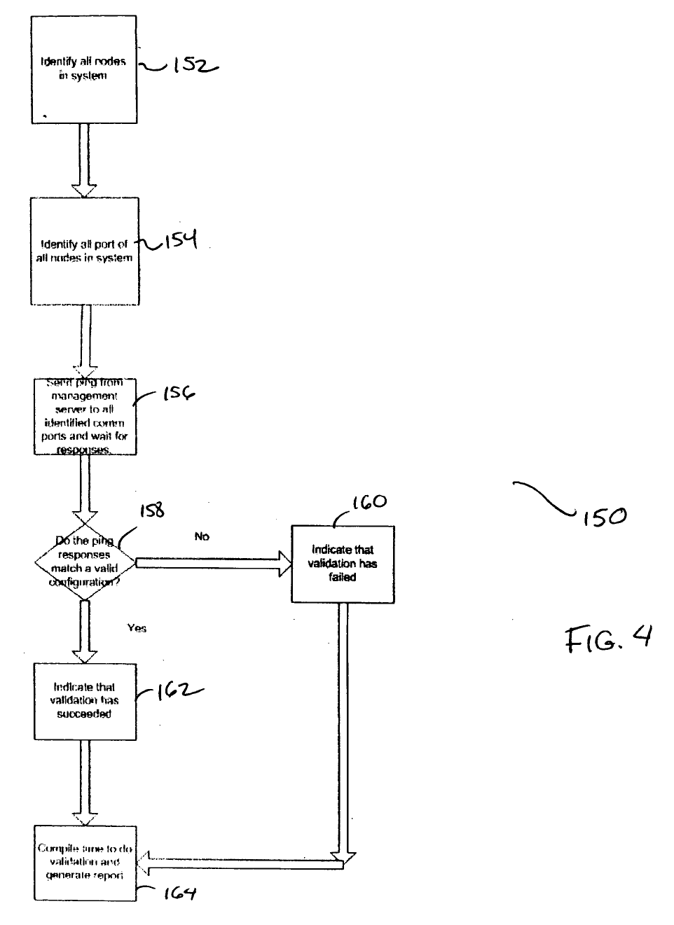

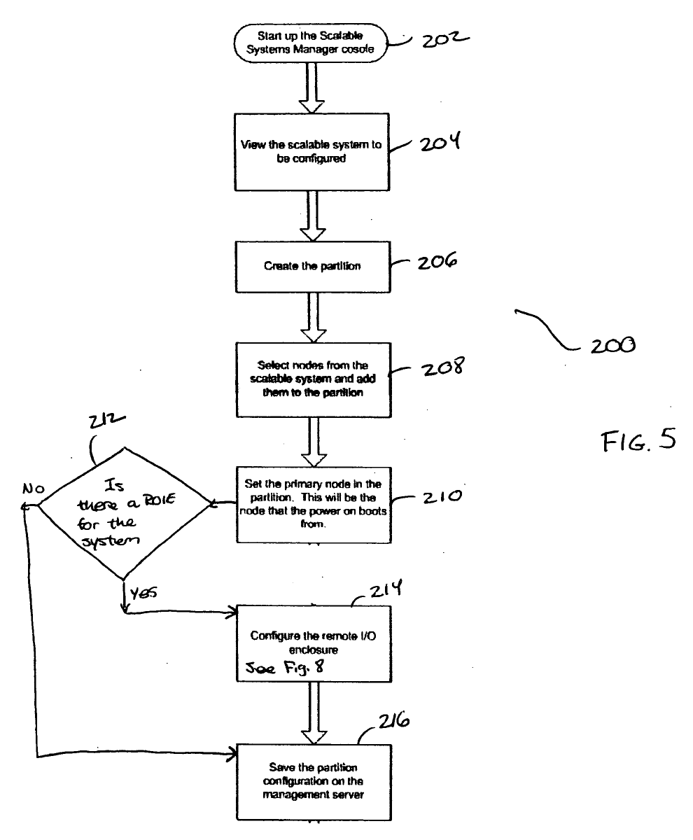

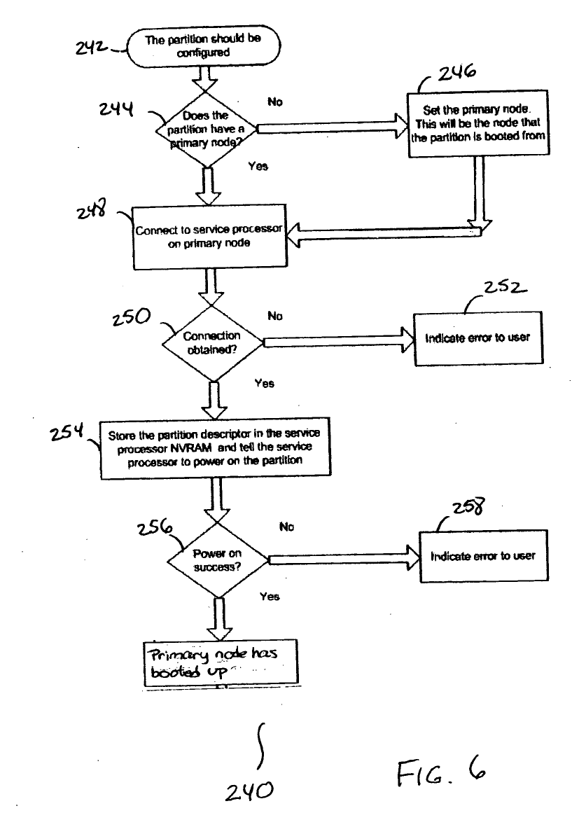

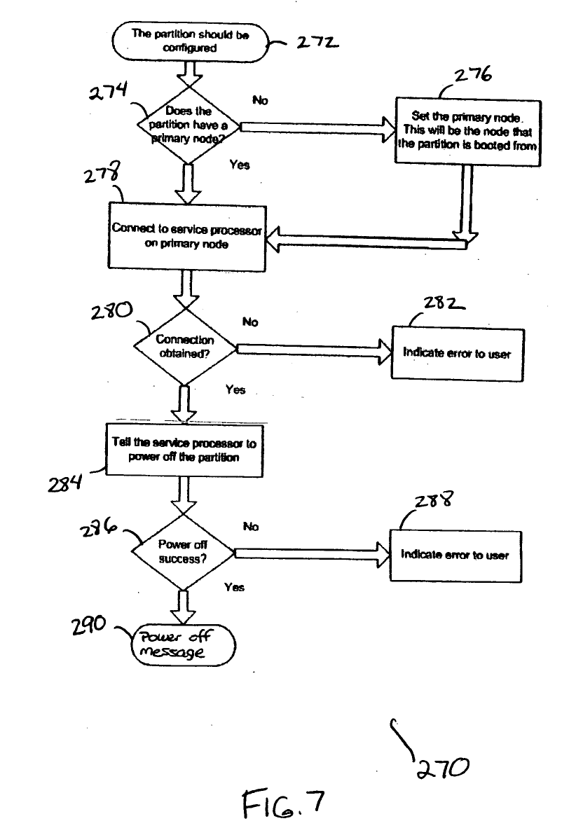

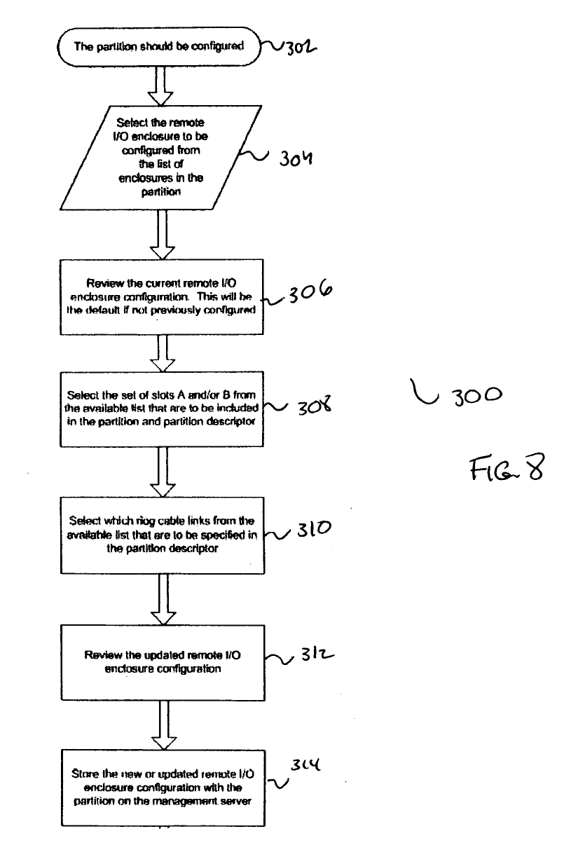

Following a positive response to the test at step (84) or completion of the discovery task at step (86), a validation tool is executed to determine the physical connection of the components of the system (88). FIG. 4 illustrates the details of execution of the validation tool. The validation tool may be executed following a positive response to the test at step (84) to determine if any of the scalable elements have been recabled. Following system discovery and validation, the management tool may be employed to configure a partition (90), as shown in detail in FIG. 5. The process of configuring a partition may include creating a scalable partition, inserting nodes into the partition, and assigning a primary node within the partition. In addition, the process of configuring a partition may include configuring a remote I/O enclosure, as shown in detail in FIG. 8. Finally, the management tool may be invoked to power on and/or off a partition being managed by the management tool (92), as shown in detail in FIGS. 6 and 7. Accordingly, following discovery of the physical platforms of the scalable computer system, the management tool may be invoked to create and manage a scalable computer system.

As shown in FIG. 2, one of the elements supported by the management tool and application is a system discovery tool. This tool communicates with each of the nodes in physical communication, i.e. wired, with the other nodes. FIG. 3 is a flow chart (100) illustrating the process of adding one or more nodes to the system using the discovery tool. Following a request for discovery of nodes in a computer system (102), the management server (30) sends a ping request to a service processor in communication with the node being discovered and waits for a response (104). An internal communication of the ping request is transmitted from the console (20) to the discovery tool (36) embedded in the management server (30) through an external communication channel. In a system with multiple service processors in communication with different nodes, the ping request is issued to each service processor through an external communication channel. Upon receipt of the ping request, the service processor(s) issues a ping to each unlocked node physically connected to the server that requested issuance of the ping (106). Thereafter, a test is conducted to determine if a response was received by the server (30) from a recipient node of the ping (108). A negative response to the test at step (108) is an indication that there is no node available at the receiving end of the ping to add to the computer system (110). However, a positive response to the test at step (108) results in the responding node being added to the system (112). For each node that is added to the computer system, the time to respond to the ping is compiled (114). The discovery tool may be used on a system that is partially discovered, as well as a system that needs configuration. Accordingly, the discovery tool is used to determine the topology of the system, and to add responding nodes to the scalable system.

In addition to the discovery tool, the application includes a verification tool to determine availability of ports in the nodes of the system. FIG. 4 is a flow chart (150) illustrating the process of validating operation of each port of each node added to the system in association with the system discovery operation. All nodes that are a part of the system are identified (152), together with the cables that connect each of the identified nodes to other nodes in the system (154). The identification of the nodes may originate from completion of the discovery tool. A communication in the form of a ping is sent from the management server (30) to all of the identified communication ports in the system (156). The ping is a bilateral communication protocol. Each port of each node that receives the ping is expected to respond to the manager with a response ping. It should be noted that all pings are executed first and then validated. A test is conducted to determine if the manager has received a response ping from an identified port within a predefined time interval (158). If the response to the test at step (158) is negative, this is an indication that the validation has failed (160). A validation failure may occur for a variety of reasons. For example, if the system is a single node system with two processor expansion modules, cabling may be limited to two of the communication ports. In another example, a response may be received from a node that is not part of the system, wherein such a response would result in generation of an error message. The validation process verifies the physical connection to the communication ports. Following failure of the validation, an error message is transmitted to the management console (20) via the management server (30) indicating failure of the validation process for the designated communication port (164). Alternatively, if the response to the test at step (158) is positive, this is an indication that the validation for the identified port was successful, i.e. the port is functioning properly. A message is transmitted to the management console (20) via the management server (30) indicating that the validation for the designated communication port was successful (162). Following validation success or failure, thC time to conduct the validation of each port is compiled, and a report is generated to convey validation information to the operator in communication with the management console (20) that issued the study (164). In one embodiment, each message transmitted to the manager includes a time interval that is indicative of the elapsed time from when the validation of the specified port was initiated until the time it has concluded.

Following receipt of either a pass message or a failure message by the manager, a report is generated for the manager summarizing the status of each port in the system. Accordingly, the validation process determines the physical connection of each communication port of a node or resource of the scalable computer system.

One of the primary elements of the manager is to configure and/or manage scalable partitions in a multinode computer system. FIG. 5 is a flow chart (200) illustrating the process of configuring a partition within the scalable computer system. The first step is to start the manager console (202). Thereafter, the operator may view a proposed configuration of the scalable system on the console (204), followed by creation of a partition (206). Once the partition has been created, the operator may select nodes from the scalable system and assign them to the partition (208). The operator then designates one of the nodes in the partition as the primary node (210), which is responsible for booting the partition. Thereafter, a test is conducted to determine if there is a remote I/O enclosure in the computer system (212). A positive response to the test at step (212) will result in a configuration of the remote I/O enclosure for the partition (214), as shown in detail in FIG. 8. However, a negative response to the test at step (212) or following configuration of the remote I/O enclosure at step (214), partition configuration information is saved on the management server (216). Accordingly, the process of configuring a partition includes selecting nodes for the partition from a list of previously discovered nodes and designating one of those nodes as the primary node in the partition.

Following creation and/or configuration of a partition, the management tool may be invoked to control delivery of power to a partition within the computer system. FIG. 6 is a flow chart (240) illustrating the process of powering on a partition of a scalable system. As shown in detail in FIG. 5, this process can only be initiated once a partition has been configured (242). A test is conducted to determine if the partition has a node designated as a primary node (244). A negative response to the test at step (244) will result in designating one of the nodes in the partition as a primary node (246). Following step (246) or a positive response to the test at step (244), a connection to the service processor on the primary node is provided (248). Thereafter, another test is conducted to determine if the connection at step (248) was successful (250). A negative response to the test at step (250) will result in the manager forwarding an error message to the operator indicating the connection between the primary node and the service processor could not be established (252). However, a positive response to the test at step (250) will result in storing a partition descriptor in the non-volatile random access memory (NVRAM) of the service processor, and forwarding instructions from the manager to power-on to the designated partition (254). The partition descriptor is a description of the partition, which includes the number of nodes in both the scalable system and scalable partition, the unique universal identifier of the nodes in the partition, the primary nodes, and the remote I/O enclosure. Following step (254), a test is conducted to determine if the power-on instruction to the designated partition was successful (256). A negative response to the test at step (256) is an indication that power could not be provided to the designated partition, and an error message is sent to the operator at the console (258). However, a positive response to the test at step (256) is an indication that the primary node of the partition has booted up and started operations (260). Accordingly, through use of the service processor and designation of one node in a partition as a primary node, the manager can transmit instructions to the primary node to power-on the designated partition.

Similar to FIG. 6, a partition may receive instructions to shut-down from the manager. FIG. 7 is a flow chart (270) illustrating the process of powering off a partition in a computer system. This process can only be initiated once a partition has been configured (272). Thereafter, a test is conducted to determine if the partition has a node designated as a primary node (274). A negative response to the test at step (274) will result in designating one of the nodes in the partition as a primary node (276). Following step (276) or a positive response to the test at step (274), a connection to the service processor on the primary node of the partition is provided (278). Thereafter, another test is conducted to determine if the connection at step (278) was successful (280). A negative response to the test at step (280) will result in the manager forwarding an error message to the operator indicating the connection between the primary node and the service processor could not be established (282). However, a positive response to the test at step (280) will result in forwarding instructions to the service processor to power off the partition (284). Thereafter, a test is conducted to determine if the power off instruction was successfully executed (286). A negative response to the test at step (286) will result in the manager forwarding an error message to the operator indication the power off instruction was not executed (288). Alternatively, a positive response to the test at step (286) will result in forwarding a message to the operator indication the power off instruction was executed (290). Accordingly, through use of the service processor and designation of one node in a partition as a primary node, the manager can transmit instructions to the primary node to power off the partition.

The scalable computer system may include one or more Remote I/O Enclosures (RIOE). Each RIOE may be configured remotely through the manager. FIG. 8 is a flow chart (300) illustrating the process of configuring a remote RIOE. It should be noted, this process can only be initiated once a partition has been configured (302). Once it has been determined that the system includes a configured partition, a RIOE is selected to be configured from a list of RIOEs in the partition (304). The current configuration of the selected RIOE is reviewed (306), and is set as the default configuration of the selected ROIE. Each RIOE has two groupings of slots available to one or more partitions. From the management console, the operator selects one or both groupings of slots to be included in the partition and associated partition descriptor (308). As part of selecting the group of slots to be included in the partition, the cables are also selected (310). For example, if the user enables slots for group one, then the cable that is attached to that group will also be selected. In some configurations, a redundant cabling is possible and in such a case the user must select whether the redundant cabling is to be used or just one cable from the RIOE to the node. The operator reviews the selected remote I/O enclosure configuration (312) as specified at steps (308) and (310). The remote I/O configuration is stored with the partition on the management server (30) (314), and the configuration is complete. Accordingly, through instructions provided at the management console, the operator can remotely assign groupings of slots of a remote I/O enclosure to one or more partitions based upon the physical connections of the grouping of slots to the computer system.

### Advantages Over the Prior Art

Nodes and system resources may be added or removed from a computer system or from a partition within the system based upon workload conditions. The process of adding or removing nodes or other system resources may be conducted statically or dynamically. The management tool leverages the service processor to enable expanded control of system resources. The management tool supports management of the computer system and/or resources within the system from a remote console.

### ALTERNATIVE EMBODIMENTS

It will be appreciated that, although specific embodiments of the invention have been described herein for purposes of illustration, various modifications may be made without departing from the spirit and scope of the invention. In particular, the operator of the management system may configure both the discovery and validation tools with a predefined time limit to receive a communication response from the nodes and ports designated to receive a ping. If the node designated in the initial communication of the discovery tool does not respond within the set time limit, a late response received from a node will prevent the node from joining the system. Similarly, a port of a node that has been added to the system in association with the discovery tool that provides a tardy response to the validation tool communication would not be added to the management tool as a functioning port. In addition, the management tool may include an event handler and action event handler to support a rules based partition failover. For example, the event filter may provide a desired operating range for a partition, and the event handler may implement predefined actions that may be implemented by the management tool in the event of a partition failover. Accordingly, the scope of protection of this invention is limited only by the following claims and their equivalents.

We claim:

1. A method for computer management comprising:
creating a scalable computer system from an unassigned scalable node;
remotely managing a scalable function in said system; and
remotely managing a scalable partition function within a partition of said system.

2. The method of claim 1, wherein said scalable function is selected from a group consisting of: inserting a scalable node into said scalable system, removing a node from said scalable system, discovering topology of said scalable system, validating wiring of said scalable system, creating a scalable partition in said scalable system, and combinations thereof.

3. The method of claim 1, wherein said scalable partition function is selected from a group consisting of: inserting a node into said partition, removing a node from said partition, setting a primary node in said partition, configuring a remote I/O enclosure, performing a power management task, and combinations thereof.

4. The method of claim 1, wherein the step managing a managing a scalable partition function includes automating partition failover in conjunction with a predefined event.

5. The method of claim 1, further comprising discovering topology of said scalable system.

6. The method of claim 5, wherein the step of discovering topology includes issuing a ping from one node across one or more ports of said node.

7. The method of claim 6, wherein the step of creating a scalable system includes said pinging node and each scalable node responding to said pinging node.

8. The method of claim 7, further comprising validating wiring of said scalable system.

9. The method of claim 8, wherein the step of validating wiring includes issuing a ping to all ports of all nodes in said scalable system.

10. The method of claim 5, further comprising issuing a discovery report subsequent to discovering topology of said system.

11. The method of claim 10, wherein said discovery report includes data selected from a group consisting of: indication of discovery success or failure for each node, discovery time, and combinations thereof.

12. The method of claim 8, further comprising issuing a validation report subsequent to verification of wiring of said ports.

13. The method of claim 12, wherein said validation report includes data selected from a group consisting of: ping response validation, indication of validation success or failure for each port, validation time, and combinations thereof.

14. An article comprising:
a computer-readable signal-bearing medium;
means in the medium for creating a scalable computer system from an unassigned node;
means in the medium for remotely managing a scalable function; and
means in the medium for remotely managing a scalable partition function with a partition of said system.

15. The article of claim 14, wherein said medium is selected from a group consisting of: a recordable data storage medium, and a modulated carrier signal.

16. The article of claim 14, wherein said scalable function is selected from a group consisting of: inserting a scalable node into said scalable system, removing a node from said scalable system, discovering topology of said scalable system, validating wiring of said scalable system, creating a scalable partition in said scalable system, and combinations thereof.

17. The article of claim 14, wherein said scalable partition function is selected from a group consisting of: inserting a node into said partition, removing a node from said partition, setting a primary node in said partition, configuring a remote I/O enclosure, performing a power management task, and combinations thereof.

18. The article of claim 14, wherein said means for managing a scalable partition function includes automating partition failover in conjunction with a predefined event.

19. The article of claim 14, further comprising means in the medium for discovering topology of said system.

20. The article of claim 19, wherein said means for discovering system topology includes a ping adapted to be issued from one node across one or more ports of said node.

21. The article of claim 20, wherein said means in the medium for creating a scalable system includes placing said pinging node and each scalable responding node into said system.

22. The article of claim 21, further comprising means in the medium for validating wiring of said scalable system.

23. The article of claim 22, wherein said means for validating wiring of said scalable system includes issuing a ping to all ports of all nodes in said system.

24. The article of claim 19, further comprising means in the medium for issuing a discovery report subsequent to discovering topology of said system.

25. The article of claim 24, wherein said discovery report includes data selected from a group consisting of: indication of discovery success of failure for each node, discovery time, and combinations thereof.

26. The article of claim 22, further comprising means in the medium for issuing a validation report subsequent to verification of wiring of said ports.

27. The article of claim 26, wherein said validation report includes data selected from a group consisting of: ping response validation, indication of validation success or failure for each port, validation time, and combinations thereof.

28. A computer management tool comprising:
a coordinator adapted to create a scalable computer system from an unassigned node;
a remote function manager adapted to control a scalable function; and
a remote partition manager adapted to control a scalable partition function within a partition.

29. The tool of claim 28, wherein said scalable function is selected from a group consisting of: inserting a scalable node into said scalable system, removing a node from said scalable system, discovering topology of said scalable system, validating wiring of said scalable system, creating a scalable partition in said scalable system, and combinations thereof.

30. The tool of claim 28, wherein said scalable partition function is selected from a group consisting of: inserting a node into said partition, removing a node from said partition, setting a primary node in said partition, configuring a remote I/O enclosure, performing a power management task, and combinations thereof.

31. The tool of claim 28, wherein said remote partition manager is adapted to automate partition failover in association with a predefined event.

32. The tool of claim 28, further comprising a topology discovery tool adapted to determine members nodes of said system.

33. The tool of claim 32, wherein said topology discovery tool is adapted to include communicating nodes as members in said system.

34. The tool of claim 32, further comprising a validation tool adapted to corroborate wiring of said system.

35. The tool of claim 34, wherein said validation tool issues a ping to all ports of all nodes in said system.

36. The tool of claim 32, further comprising a topology discovery report adapted to be issued subsequent to said member node determination.

37. The tool of claim 36, wherein said topology discovery report includes data selected from a group consisting of: indication of discovery success or failure for each node, discovery time, and combinations thereof.

38. The tool of claim 34, further comprising a validation report adapted to be issued subsequent to corroboration of said wiring.

39. The tool of claim 38, wherein said validation report includes data selected from a group consisting of: ping response validation, indication of validation success or failure for each port, validation time, and combinations thereof.
